(19) United States
(12) Patent Application Publication
(10) Pub. No.: US 2021/0103445 A1
(43) Pub. Date: Apr. 8, 2021

(54) METHOD AND APPARATUS FOR PREPROCESSING DATA TRANSFER COMMANDS

(71) Applicant: Goke US Research Laboratory, Santa Clara, CA (US)

(72) Inventors: Steven Schauer, Loveland, CO (US); Engling Yeo, San Jose, CA (US)

(21) Appl. No.: 16/592,682

(22) Filed: Oct. 3, 2019

(51) Int. Cl. G06F 9/38; G06F 9/30

(52) U.S. Cl. CPC G06F 9/3802; G06F 9/3004

(57) ABSTRACT

Methods and apparatus for preprocessing commands by a data transfer device. A prefetch processor creates a list of contiguous pointers in a local memory coupled to a controller CPU, based on pointers stored by a host processing system coupled to the data transfer device. When the controller CPU is ready to execute a command, it uses the pointer list in the local memory to determine where to transfer data associated with the command.

### BACKGROUND

### I. Field of Use

The present invention relates to the field of computing and more specifically to efficiently pre-processing data transfer commands by a processing device.

### II. Description of the Related Art

Flash memory—also known as flash storage—is a type of non-volatile memory that is gaining widespread use in enterprise storage facilities, offering very high performance levels catering to customer expectations for performance, efficiency and reduced operational costs. Such flash memory is typically realized as high-capacity solid state hard drives (SSDs). Several years ago, a technical interface specification emerged that defines direct access protocols to such flash memory drives directly over a PCIe serial bus, known as Non-Volatile Memory Express (NVMe). Since its release in 2013, NVMe has gained widespread acceptance, with version 1.4 just released in June, 2019. The NVMe technical interface, version 1.4, is incorporated by reference herein in its entirety.

NVMe provides low-latency and parallelism between a host and one or more peripheral device, such as one or more SSDs, or between a peripheral device and multiple hosts. This is achieved using an architecture that defines multiple submission and completion queues, where submission queue commands are provided to the submission queues by the host, and completion entries are provided by the peripheral device(s) to the completion queues. The submission commands may comprise read and write commands, each of these commands comprising a Scatter Gather List (SGL) descriptor or a Physical Region Pointer (PRP) entry in the received NVMe command, to identify memory locations where data will be stored or retrieved. As each command is received by the SSD, a controller onboard the SSD processes the commands, including processing the SGL descriptor or PRP entries, more generally referred to herein as “pointers”. Processing SGL descriptors and PRP entries can be a time-consuming process, because the SGL descriptors or PRP entries may require numerous read or write cycles.

The NVMe interface specification allows each command to include two PRP entries, or one SGL descriptor, each identifying an area where data is to be transferred. If more than two PRP entries are necessary to describe where the data is stored, then a pointer to a PRP List buffer containing the PRP entries is provided in many types of NVMe commands.

Likewise, if more than one SGL descriptor is necessary to describe where data is to be transferred, then an SGL descriptor in an NVMe command comprises a SGL Segment descriptor. The Segment descriptor is a pointer that identifies an address in a buffer memory containing a list of SGL descriptors. The NVMe interface specification defines five different types of SGL descriptors and one vendor specific descriptor.

FIG. 1 illustrates this point. An NVMe read or write command may comprise an SGL Segment descriptor that points to a list of SGL descriptors stored in memory. In this example, an SGL Segment descriptor in a read command points to a plurality of SGL descriptors (collectively, an SGL segment), grouped into two areas of the memory, shown as SGL list 1 and SGL list 2. Each SGL list, or segment, in the memory comprises a descriptor type, comprising 00 h (indicating an SGL Data Block), 020 h, indicating an SGL Segment (i.e., a pointer to one or more SGL descriptors), or 030 h, indicating a pointer to the last segment descriptor of this command. A controller CPU inside a prior art solid state drive must access each SGL descriptor in memory in order to execute the read command.

In current SSD controller operations, retrieving a single PRP/SGL entry/descriptor causes latency for the device, especially when the second PRP entry in a command is a pointer to multiple PRP entries, or if an SGL descriptor is an SGL Segment descriptor or an SGL last segment descriptor. This is because the controller must “walk” the entire list of PRP entries or SGL descriptors before other commands can be processed. The problem of latency may also be experienced by other processing devices besides data storage devices, such as computer systems, bus controllers, mobile phones, network-connected cameras, or any device that is involved in the transfer of data from one location to another.

It would be desirable, therefore, to minimize the latency caused by prior art pointer processing.

### SUMMARY

The embodiments herein describe methods and apparatus for preprocessing commands from a host processing system by a data transfer device. In one embodiment, a data transfer device is described, comprising a memory for storing processor-executable instructions and a pointer list that identify pointers to memory addresses where data is to be transferred, a controller CPU, and a prefetch processor for executing the processor-executable instructions that causes the data transfer device to retrieve, by the prefetch processor, a first pointer from the first command, retrieve, by the prefetch processor, a plurality of other pointers from a host processing system memory of the host processing system based on the first pointer, store, by the prefetch processor in the memory, the plurality of other pointers in the pointer list, and process, by the controller CPU, the first command using the plurality of pointers in the pointer list.

In another embodiment, a method is described, performed by a data transfer device, for preprocessing a first command from a host processing system coupled to the data transfer device, comprising, retrieving, by a prefetch processor, a first pointer from the first command, retrieving, by the prefetch processor, a plurality of other pointers from a host processing system memory of the host processing system based on the first pointer, storing, by the prefetch processor in a local memory, the plurality of other pointers in a pointer list, and processing, by the controller CPU, the first command using the plurality of pointers in the pointer list.

### BRIEF DESCRIPTION OF THE DRAWINGS

The features, advantages, and objects of the present invention will become more apparent from the detailed description as set forth below, when taken in conjunction with the drawings in which like referenced characters identify correspondingly throughout, and wherein:

FIG. 1 illustrates a conceptual diagram of an NVME command comprising a pointer that identifies a plurality of other pointers, each of pointer and plurality of other pointers processed by a controller CPU;

FIG. 2 illustrates a block diagram of one embodiment of a data transfer device in accordance with the teachings herein;

FIGS. 3A and 3B are flow diagrams illustrating one embodiment of a method performed by the data transfer device of FIG. 2 for preprocessing commands and for constructing a pointer list based on a list of pointers stored in memory of a host processing system;

FIG. 4 is a diagram of a read or write command in accordance with the NVMe interface specification;

FIG. 5 is a diagram of three non-contiguous SGL Segments and a list of SGL descriptors constructed from the SGL Segments; and

FIG. 6 is a diagram of an allocated memory space in a memory of the data transfer device as shown in FIG. 2, storing four contiguous pointer lists.

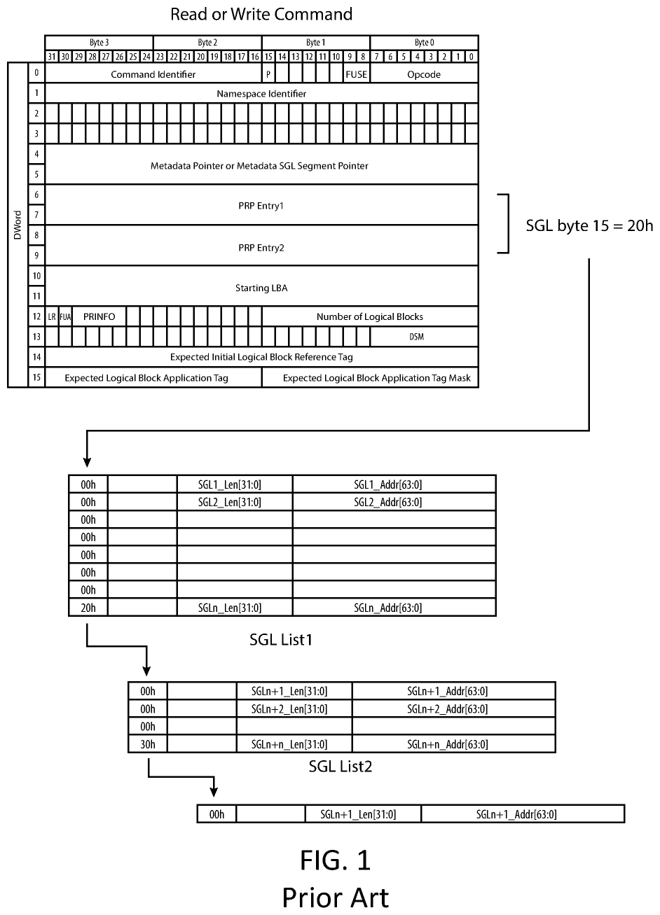

### DETAILED DESCRIPTION

The present disclosure describes an apparatus and method for preprocessing computer data transfer commands (“commands”) by a data transfer device to reduce latency when the commands reference numerous PRP entries or SGL descriptors, more generally referred to herein as “pointers”. Such pointers comprise an address in memory where to source data or to transfer data and a size, or length, of the data to be sourced or transferred. While the present disclosure describes a particular embodiment of a data transfer device, i.e., an SSD, in other embodiments, the data transfer device could comprise some other device or circuitry, such as a computer, a buss controller, a mobile phone, a network-connected camera, or any other device or circuitry that transfers data from one location to another.

In general, a controller CPU of a prior art data transfer device may need to “walk” a list of pointers stored in a host processing system to identify each memory location where data will be sourced or transferred, which is a time-consuming process. The word “transferred” as used herein comprises reading or writing data to or from a memory location (such as RAM, scratch pad memory, buffer memory, flash NAND, etc.) or, more generally, moving data from one location to another In this disclosure, embodiments of an invention are described that reduce this latency using a “prefetch processor”, separate from a controller CPU, that constructs a “pointer list” in local memory from a plurality of pointers identified in data transfer commands provided by one or more host processing systems, thus allowing efficient access to the pointers by the controller CPU. The term “controller CPU” as used herein refers to a processor that performs a primary function of a data transfer device, distinguished from external components such as main memory and I/O circuitry. For example, the primary function of an SSD is to store and retrieve large volumes of data and a controller CPU refers to a processor that regulates the storage and retrieval process.

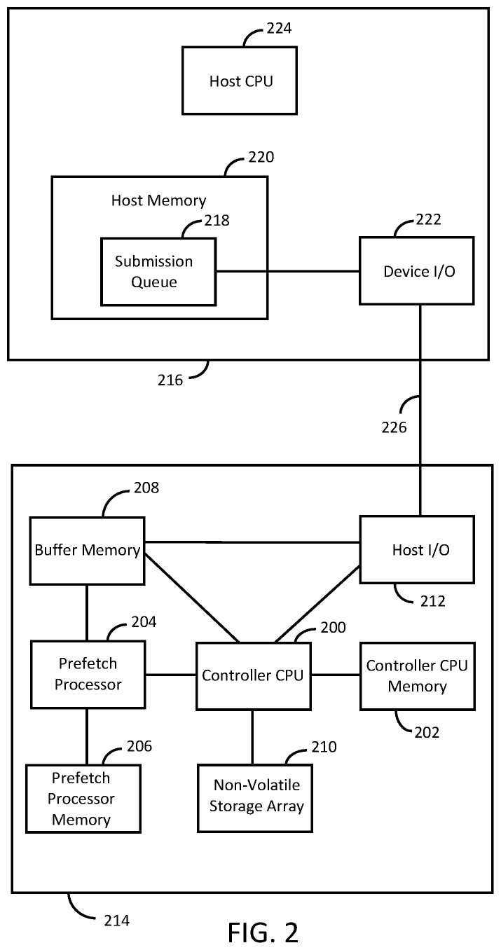

FIG. 2 illustrates a block diagram of one embodiment of a data transfer device 214 in accordance with the teachings herein, in this example, an SSD. FIG. 2 shows controller CPU 200, CPU memory 202, prefetch processor 204, prefetch processor memory 206, buffer memory 208, non-volatile storage array 210, and host I/O interface 212. It should be understood that the functional components shown in FIG. 2 could be coupled to one another in a number of different arrangements, and that some functional blocks have been omitted for clarity in order to focus on the blocks needed for implementation of this embodiment of the invention.

In one embodiment, data transfer device 214 is configured in accordance with the NVMe specification technical interface, version 1.4 (herein, the “NVMe interface specification”), which defines multiple submission and completion queues stored in a host computer memory coupled to data transfer device 214 via a high-speed data bus, or over “fabrics”, i.e., a network connection, where submission queue commands (i.e., data transfer commands such as read, write, erase, etc., administrative commands, etc.) are provided to the submission queues by a host processor. The architecture further defines doorbell registers that are used by the host processor to notify data transfer device 214 of each submission queue command placed into each submission queue. In one embodiment, the submission queue commands are then retrieved by controller CPU 200 via host I/O 212 and stored sequentially in buffer memory 208 until they are processed by controller CPU 200. In another embodiment, the commands are left in the submission queue(s) until controller CPU 200 is ready to execute them.

In prior art devices, controller CPU 200 may process the commands using, in some embodiments, Physical Region Pointers (PRPs) or Scatter Gather Lists (SGLs) (more generally referred to herein as “pointers”) to determine a memory location where data is to be transferred. The memory locations indicated by the pointers may be located within a memory of a host processing system, or to a memory located within data transfer device 214, such as a buffer memory, non-volatile storage array, system RAM, etc. The NVMe interface specification specifies that each command may include two PRP entries, or one SGL descriptor. A first PRP entry in a command comprises an address of a page in a memory where data is to be transferred, and an offset. If more than two PRP entries are necessary to describe the location of data to be transferred, then a pointer to a list of PRP entries is provided in by a second PRP entry in the command, each of the PRP entries in the PRP list comprising an address and an offset, typically, again, zero. An SGL descriptor can reference different sizes of data, and therefore comprises a length field specifying the length, or size of data being addressed, and an address in a memory where the data is to be transferred. If more than one SGL descriptor is necessary to describe the data to be transferred, then the SGL descriptor in the command is assigned a “type” of “SGL Segment” (or SGL Last Segment). The SGL Segment is a pointer to a list of SGL descriptors, and a plurality of descriptors may be contiguously stored as a “segment”. In either of these cases, a controller CPU may need to “walk” the list of PRP entries and SGL descriptors to obtain all of the information necessary to execute the command, which may create a bottleneck when numerous PRP entries or SGL descriptors are present.

Instead of having controller CPU 200 retrieve all of the pointers for each command, this task is passed to prefetch processor 204. Prefetch processor 204 retrieves pointer information from the commands and constructs a pointer list (in one embodiment, each pointer a PRP entry or an SGL descriptor) to memory locations needed to execute the command. The pointers in the pointer list are generally copies of the pointers stored in the host processing system memory or buffer memory 208, except that some pointers are modified slightly in order to allow controller CPU 200 to process all of the pointers in the pointer list sequentially, without having to access the system IO bus, and also to eliminate having to jump from one memory location to another. In one embodiment, the pointers in the commands are stored sequentially in buffer memory 208, memory 202, or some other memory that may be quickly accessed by controller CPU 200 (referred to herein as a “local memory”), which allows for faster processing by controller CPU 200 than if controller CPU 200 was responsible for obtaining each pointer from the host processing system, as in the prior art. The last pointer in the pointer list for a given command is assigned a predetermined value, such as 0 fh by prefetch processor 204, so that controller CPU 200 can identify the last pointer in the pointer list associated with a particular command. The predetermined value, or code, can be specified as a “vendor specific” value, as that term is defined the NVMe interface specification, and may be contained within an SGL Segment descriptor or PRP entry in the pointer list to identify the selected vendor specific value. Prefetch processor 204 provides an indication to controller CPU 200 when the pointer list for each command is complete, such as incrementing a firmware counter or sending controller CPU 200 an interrupt.

At some time later, controller CPU 200 processes one of the commands that was preprocessed by prefetch processor 204. Controller CPU 200 transfers the data referenced by the command by transferring portions of the data, such as reading or writing data to/from a host buffer memory to non-volatile storage array 210, in accordance with the pointers that are stored in the pointer list, until the last pointer has been processed.

In one embodiment, SGL descriptors and PRP entries are converted into a common pointer format comprising a starting address and a data length before being stored in the pointer list, so that data transfer device 214 can accept commands from a host computer using either SGLs or PRPs. This also allows for a much simpler and efficient design of controller CPU 200.

Prefetch processor 204 may construct multiple pointer lists and store them simultaneously in local memory, each pointer list associated with a particular command. In one embodiment, as the allocated memory space in local memory is consumed by multiple pointer lists, prefetch processor 204 may begin to slow the rate at which it preprocesses commands, until it stops preprocessing commands when the allocated space in local memory for pointer lists is full. Generally, processing resumes after controller CPU 200 has processed at least one of the commands that had been preprocessed by prefetch processor 204, where the pointer list associated with the processed command is cleared from local memory after controller CPU 200 has finished processing the command.

Referring back to FIG. 2, controller CPU 200 is configured to provide general operation of data transfer device 214 by executing processor-executable instructions stored in controller CPU memory 202, for example, executable computer code. Controller CPU 200 comprises one or more microprocessors, microcontrollers, custom ASICs, PGAs, and/or similar circuitry, and/or supporting, peripheral circuitry, to execute the processor-executable instructions stored in controller CPU memory 202. The microprocessors, microcontrollers, custom ASICs, and/or PGAs, are selected based on factors such as computational speed, cost, size, and other factors.

Controller CPU memory 202 is coupled to controller CPU 200, comprising one or more information storage devices, such as ROM, RAM, flash memory, or other type of electronic, optical, or mechanical memory device. In some embodiments, memory 202 comprises multiple types of memory, such as a combination of integrated or separate volatile and non-volatile memory devices. Controller CPU memory 202 is used to store the processor-executable instructions for operation of data transfer device 214, including instructions that cause controller CPU 200 to execute commands received from one or more host processing systems, such as data storage and retrieval from non-volatile storage array 210. In some embodiments, memory 202 is used to store one or more pointer lists. In one embodiment, at least a portion of the processor-executable instructions define a Flash Translation Layer. It should be understood that in some embodiments, CPU memory 202 is incorporated into controller CPU 200 and, further, that CPU memory 202 excludes media for propagating signals.

Prefetch processor 204 is coupled to controller CPU 200, comprising one or more microprocessors, microcontrollers, custom ASICs, PGAs, and/or similar circuitry, and/or supporting, peripheral circuitry, to execute processor-executable instructions stored in prefetch processor memory 206 specifically for preprocessing commands stored in buffer memory 208 or in a host processing system memory, i.e., to create one or more pointer lists in local memory for commands that indicate multiple pointers. The microprocessors, microcontrollers, custom ASICs, and/or PGAs, are selected based on factors such as computational speed, cost, size, and other factors.

Prefetch processor memory 206 is coupled to prefetch processor 204, comprising one or more information storage devices, such as ROM, RAM, flash memory, or other type of electronic, optical, or mechanical memory device. In some embodiments, prefetch processor memory 206 comprises multiple types of memory, such as a combination of integrated or separate volatile and non-volatile memory devices. Prefetch memory 206 is used to store the processor-executable instructions that cause prefetch processor 204 to construct the pointer lists. It should be understood that in some embodiments, prefetch processor memory 206 is incorporated into prefetch processor 204 and, further, that prefetch processor memory 206 excludes media for propagating signals.

Buffer memory 208 is coupled to prefetch processor 204 and controller CPU 200, comprising one or more information storage devices, typically volatile in nature, RAM, SRAM, SDRAM, DRAM, DDRAM, or other type of volatile, electronic, optical, or mechanical memory device. Buffer memory 208 may be used to store commands received from one or more host processing systems and, in some embodiments, to store one or more pointer lists, created by prefetch processor 204. Buffer memory 208 excludes media for propagating signals.

Non-volatile storage array 210 is coupled to controller CPU 200, comprising one or more non-transitory information storage devices, such as flash memory, or some other type of non-volatile, electronic, optical, or mechanical memory device, used to store large amounts of data from one or more host processing systems. In one embodiment, non-volatile storage array 210 comprises a number of NAND flash memory chips, arranged in a series of physical banks, channels and/or planes, to provide multiple terabytes of data storage. Non-volatile storage array 210 excludes media for propagating signals.

Host I/O 212 comprises circuitry and firmware to support a physical connection and logical emulation to one or more host processing systems, either locally over a high-speed data bus (such as a PCIe bus) or remotely, via, for example, NVMe-OF ((NVMe over fabrics) via a wide-area network such as the Internet.

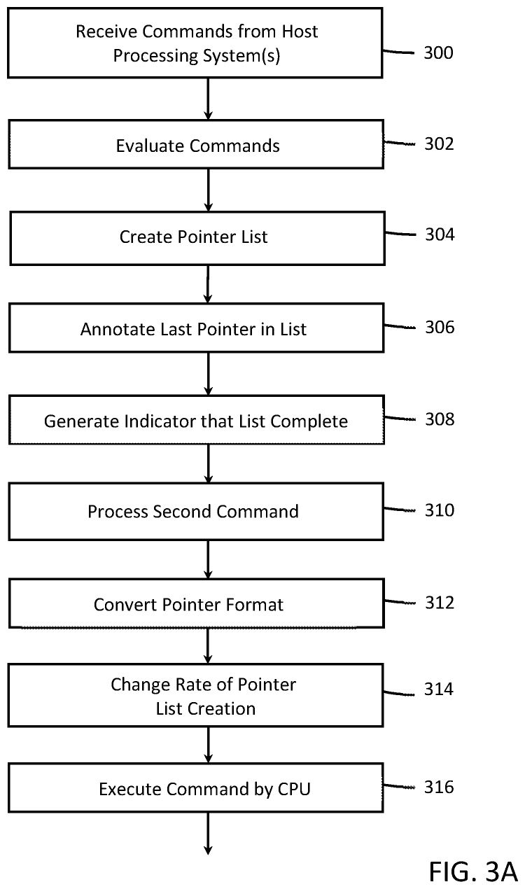

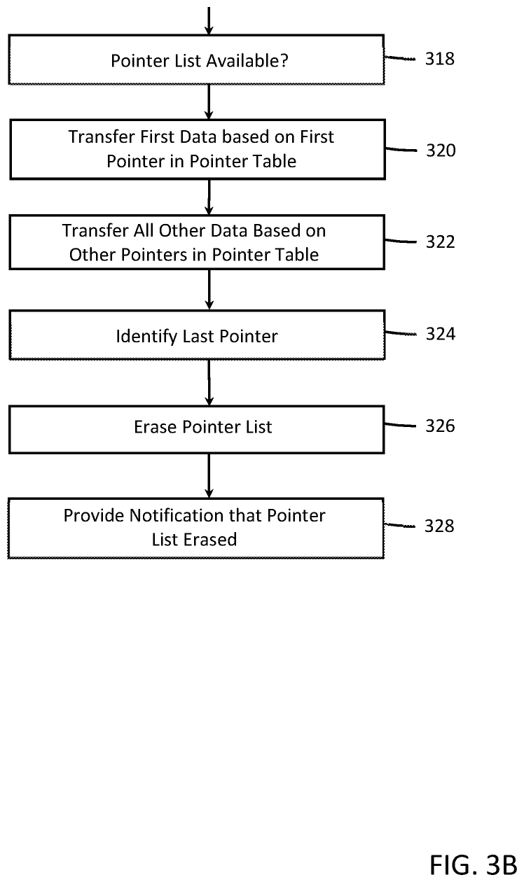

FIG. 3 is a flow diagram illustrating one embodiment of a method performed by data transfer device 214 for preprocessing commands from a host processing system and for constructing a pointer list based on a plurality of pointers stored in a local memory of the host processing system, such as a List RAM memory, by executing processor-executable instructions stored in prefetch processor memory 206, controller CPU memory 202, or both. It should be understood that although the method shown in FIG. 3 sometimes references a particular embodiment where data transfer device 214 is configured in accordance with the NVMe technical interface, the same inventive concepts could be used in other data transfer devices that utilize different technical interfaces. It should further be understood that in some embodiments, not all of the steps shown in FIG. 3 are performed and that the order in which the steps are carried out may be different in other embodiments. It should be further understood that some minor method steps have been omitted for purposes of clarity. Finally, for the remainder of the description of the method, the terms PRP entry, SGL descriptor and pointer may be used interchangeably.

At block 300, data transfer device 214 receives a number of commands from one or more host processing systems via host I/O 212. A host processing system typically comprises a host processor, a host memory, buffer memory and I/O circuitry separate from data transfer device 214, coupled to each other via a high-speed data bus, such as a PCIe bus, or via one or more networks. The commands may comprise read commands for retrieving previously-stored data from data transfer device 214 and write commands for storing data from the host processing systems to data transfer device 214, although numerous other commands may be received by data transfer device 214 from the host processing system and preprocessed by prefetch processor 204. In one embodiment, data from the host processing system may be stored or retrieved from non-volatile storage array 210. In one embodiment, commands are retrieved/received by data transfer device 214 from a buffer memory in the host processing system and stored in local memory of data transfer device 214, generally in the order in which they are received, until controller CPU 200 can operate on them. In another embodiment, the commands may be stored in a memory of the host processing system until controller CPU 200 is ready to execute them. Typically, controller CPU 200 executes a single command at a time, processing a next command when execution of a current command has been completed, i.e., data associated with the command has transferred from one location to another, such as between a host processing system memory and buffer memory 208, between a host processing system memory and non-volatile storage array 210, etc.

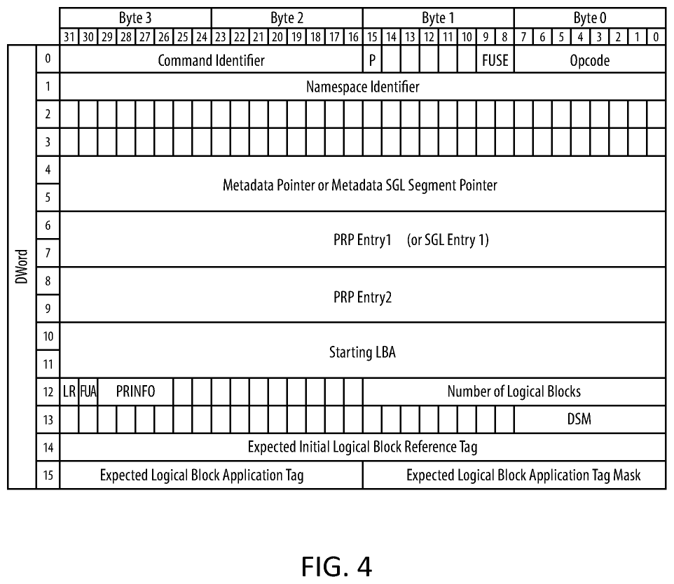

In some embodiments, the commands are formatted in accordance with the NVMe interface specification. For NVMe commands, Dwords 6-9 are used to indicate up to 2 RPR entries or a single SGL descriptor, as shown in FIG. 4. If a command uses PRP for data transfer, then the Metadata Pointer, PRP Entry 1, and PRP Entry 2 fields are used. If the command uses SGLs for the data transfer, then the Metadata SGL Segment Pointer and SGL Entry 1 fields are used.

PRP Entry 1 is a pointer that identifies a first memory location where data is to be stored or retrieved, while PRP Entry 2 is a pointer that identifies either a second memory location or points to a one or more lists of PRP entries that identify a plurality of other memory locations where the data is to be transferred. PRP Entry 2 may comprise a pointer that identifies a list of PRP entries, where the last entry in the list can point to another list of PRP entries, and so on, when the amount of data to be transferred crosses more than one memory page boundaries, i.e., a) the command data transfer length is greater than or equal to two memory pages in size but the offset portion of the PBAO field of PRP 1 is non-zero, or b) the command data transfer length is equal in size to more than two memory pages and the Offset portion of the PBAO field of PRP 1 is equal to 0 h.

SGL Entry 1 is a pointer that identifies either a single block of memory (for example, if the SGL segment is an SGL Data Block or Keyed SGL Data Block or a Transport SGL Data Block descriptor), or a pointer to one or more SGL descriptors arranged in groupings called “SGL Segments”, where the data is to be transferred. If more than one SGL descriptor is needed to describe the data transfer associated with a command, then the SGL Entry 1 may also be referred to as an SGL Segment (or a Last Segment), as described in section 4.4 of the NVMe interface specification.

At block 302, in response to determining that a command is ready for preprocessing, i.e., that a command has been stored in a host processing system memory, i.e., a submission queue in one embodiment or that a command has been received and stored in buffer memory 208, prefetch processor 204 may first evaluate the command to determine if it, or any other commands, require more than a predetermined number of memory accesses in order for controller CPU 200 to execute the command. “Memory accesses” means that a command requires more than 2 read or write cycles to a memory location, such as memory locations local memory or external to data transfer device 214, i.e., a memory as part of the host processing system or some other memory of another host processing system coupled to data transfer device 214, in order to transfer the data referenced by the command. In a data transfer device 214 that utilizes the NVMe interface specification, a memory access is associated with each PRP entry or an SGL descriptor. Thus, the number of PRP entries or SGL descriptors is indicative of the number of memory accesses required to process a command. In this example, if the predetermined number of memory accesses is set to 3, prefetch processor 204 may evaluate the one or more commands to determine if any indicate 3 or more PRP entries or SGL descriptors to describe the data being transferred. In one embodiment, prefetch processor 204 determines that the number of memory accesses is exceeded when PRP Entry 2 crosses more than one memory page boundary (i.e., has an offset greater than zero, indicating that a page boundary will be exceeded). In another embodiment, prefetch processor 204 determines that the number of memory accesses is exceeded when an SGL descriptor is of an SGL Segment type or an SGL Last Segment type. In another embodiment, prefetch processor 104 evaluates the number of logical blocks identified in Dword 12 to determine whether 2 or more memory accesses is needed in order to transfer the data.

At block 304, when prefetch processor 204 determines that a command requires multiple memory accesses for controller CPU 200 to execute the command, prefetch processor 204 creates a pointer list comprising all of the data pointers necessary to execute the command. In an embodiment utilizing NVMe, the pointers comprise PRP entries or SGL descriptors, and prefetch processor 204 identifies a list of PRP entries or SGL descriptors based on PRP entry 2 or an SGL Segment or Last Segment in the command, plus any PRP entries or SGL descriptors linked to the list of PRP entries or SGL descriptors (i.e., a linked list), stored in a host processing system memory, such as an allocated system buffer memory. Prefetch processor 204 then copies the information in the pointers (or PRP entries or SGL descriptors) and places the copied information sequentially in the pointer list stored in local memory internal to data transfer device 214, modifying a descriptor field in some of the pointers so that a) controller CPU reads each pointer sequentially, and b) so that the last pointer indicates that it is the last pointer in the list associated with the command. The term “copied” means that information such as a descriptor field, an address, a size and/or an offset is copied as a respective pointer in the pointer list (i.e., as a pointer, PRP entry or SGL descriptor), while the descriptor field may be modified by prefetch processor 204, as described below. The pointer list is stored in a predesignated area within local memory, where multiple lists of pointers may be stored, each list associated with a different command.

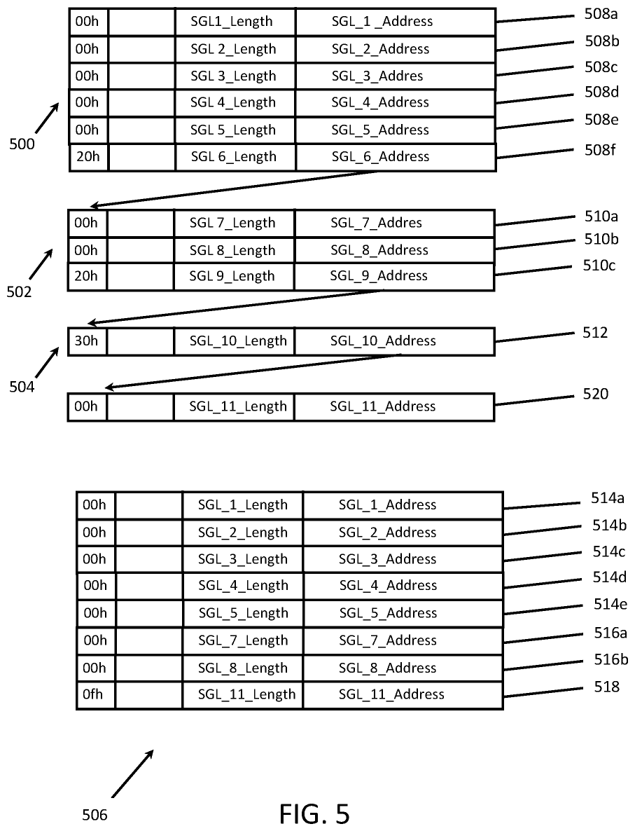

Referring to FIG. 5, which shows three non-contiguous SGL Segments, SGL Segment 500 (6 SGL descriptors), 502 (3 SGL descriptors) and 504 (1 SGL descriptor) and a pointer list 506, prefetch processor 204 creates the pointer list 506 using the SGL descriptors in Segments 500, 502 and 504 as follows. It should be understood that although FIG. 5 illustrates a particular number of SGL segments, each segment having a particular number of SGL descriptors, in other embodiments, the number of segments and the number of SGL descriptors could be different, with the total number of descriptors numbering in the hundreds or even thousands. It should also be understood that pointers or PRP entries could be used instead of SGL descriptors.

In the case of SGL descriptors, each descriptor comprises a data length (as SGL descriptors can specify a different amount of memory to be accessed) and a physical memory address (i.e., SGL_n_Address) where a portion of data associated with the command is to be transferred. In the case of PRP entries, each PRP entry comprises a physical memory address and an offset, and each PRP entry in a PRP list generally has the offset set to 0. Different host computing systems may support different PRP lengths. For example, a first host computing system may only support PRP lengths of 4 kB, while a second host computing system may only support PRP lengths of 8 kB. Because different PRP lengths may be encountered by prefetch processor 204, prefetch processor 204 may first need to determine the size of PRP entries from any particular host processing system, for example, by referencing a table stored in local memory that identifies each host processing system coupled to data transfer device 214 and a PRP length associated with each host processing system. Prefetch processor then determines the length, or size, of the data transfer associated with the command, for example, by reading a “number of logical blocks” field in an NVMe command (as shown in FIG. 4), or similar field in another command format. Prefetch processor 204 then knows to create a number of pointers in the pointer list, determined by dividing the length of the data transfer (in this case 128 kB) by the PRP length (in this case 8 kB), or 16 pointers. The data in each of the 16 pointers is found by “walking” a linked list of PRP entries, a first pointer of the linked list identified by the PRP entry in the command.

Prefetch processor 204 first reads a memory address identified by the SGL Segment in the command, then retrieves SGL descriptor 508a from a memory of the host processing system, using the addressing information provided in the SGL Segment in the command, and copies the information within SGL descriptor 508a it to SGL descriptor 514a in local memory reserved for multiple pointer lists created by prefetch processor 204. Only one pointer list 506 is shown in FIG. 5. SGL descriptor 508a, like the other SGL descriptors, comprises a descriptor field containing, in this embodiment, either 00 h, 20 h, or 30 h, a size or length data to be transferred, and a memory address of where to transfer data associated with the command. Prefetch processor 204 uses the descriptor to determine whether to process the next contiguous SGL descriptor in a Segment, to process a next SGL descriptor in a different SGL Segment (i.e., SGL descriptor 510a in SGL Segment 502), or stop processing further SGL descriptors. If an SGL descriptor comprises 00 h in the descriptor field, prefetch processor 204 is directed to read the next SGL descriptor. Thus, in the example of FIG. 5, prefetch processor 204 copies the information in SGL descriptors 408a-408e into pointer list 506 in buffer memory 208.

If prefetch processor 204 encounters 20h in the descriptor field, as in the case when prefetch processor 204 reads SGL descriptor 508f, prefetch processor 204 does not copy the information within SGL descriptor 508f to pointer list 506. Instead, prefetch processor 204 uses the address information and the data length information (in this case SGL 6 Length value) in SGL descriptor 508f to read another SGL descriptor stored in another SGL Segment at the address indicated in the address field, i.e., SGL descriptor 510a in SGL Segment 502. Since SGL descriptor 510a comprises a descriptor of 00 h, prefetch processor 204 copies the information within SGL descriptor 510a and stores it sequentially in pointer list 506, i.e., at location 516a. Prefetch processor 204 next processes SGL descriptor 510b in the same way, creating pointer 516b in pointer list 506, but then encounters SGL descriptor 510c, which comprises a descriptor of 20h, indicating that SGL descriptor 510c is merely a pointer and length value to another, discontinuous SGL descriptor, i.e., SGL descriptor 512, as a single entry in SGL Segment 504.

At block 306, prefetch processor 204 processes SGL descriptor 512, in one embodiment comprising a descriptor of 30h, indicating that SGL descriptor 512 is a pointer to the last SGL descriptor needed to execute the command, i.e., SGL descriptor 520 (which may be a contiguous SGL segment with SGL segment 512, or discontinuous as shown in FIG. 5). Prefetch processor 204 does not copy the information in SGL descriptor 512 into pointer list 506. Rather, it reads the information in SGL descriptor 520 and creates pointer 518 in pointer list 506. Then, prefetch processor stops creating any further pointers in pointer list 506, because prefetch processor knows that SGL descriptor 520 was the last SGL descriptor needed to transfer all of the data associated with the command.

In another embodiment, descriptor 30h is not used to indicate a last SGL descriptor. In this embodiment, prefetch processor 204 determines the last SGL descriptor by calculating the total length of the transfer (based on the command information of the total number of sectors, or in the event that the command is not a Read or Write command, the data length format specific to the command, such as the number of DWords or Bytes), and then adding the data length indicated by each processed SGL descriptor to track a cumulative data transfer length. When the cumulative data transfer length equals the total length of the transfer, as indicated by the command, prefetch processor 204 stops processing further SGL descriptors associated with the command.

Thus, prefetch processor 204 processes SGL descriptors 508a through 520, copying the contents of these descriptors as SGL descriptors 514a through 518, not including SGL descriptors 508f, 510c or 512, as these descriptors are Segment (or Last Segment) descriptors. Thus, the contents of SGL 508a are copied to pointer list 506 as SGL segment 514a, the contents of SGL 508b are copied to pointer list 506 as SGL segment 514b, the contents of SGL 508c are copied to pointer list 506 as SGL segment 514c, the contents of SGL 508d are copied to pointer list 506 as SGL segment 514d, the contents of SGL 508e are copied to pointer list 506 as SGL segment 514e, the contents of SGL 510a are copied to pointer list 506 as SGL segment 516a, the contents of SGL 510b are copied to pointer list 506 as SGL segment 516b, and the contents of SGL 520 are copied to pointer list 506 as SGL segment 518, with the descriptor field changed from 00 h to a predetermined value, such as 0 fh, to indicate that SGL segment 518 is the last pointer in pointer list 506.

At block 308, in response to determining that no further SGL descriptor are needed to execute the command, prefetch processor 204 generates an indication for controller CPU 200 that pointer list 506 is ready for use by controller CPU 200 to execute the command. In one embodiment, an interrupt is generated and provided to controller CPU 200. In another embodiment, a firmware counter is incremented that is available to both prefetch processor 204. The firmware counter may be maintained by controller CPU 200 and controller CPU and incremented each time a pointer list has been constructed in buffer memory 208.

At block 310, prefetch processor 204 may process a second command from the host processing system (or a different host processing system) in the same way as described above, before controller CPU 200 begins processing the first or second commands. Prefetch processor 204 creates a second pointer list associated with the second command, in one embodiment, contiguously in buffer memory 208 or memory 202 after the last SGL descriptor in the first pointer list, so that controller CPU 200 knows to simply increment the address used to access SGL descriptor 518 in order to read the first SGL descriptor of the second pointer list. Prefetch processor 204 may processes a number of further commands stored in buffer memory 208 until the area allotted to the pointer lists in buffer memory 208 is consumed.

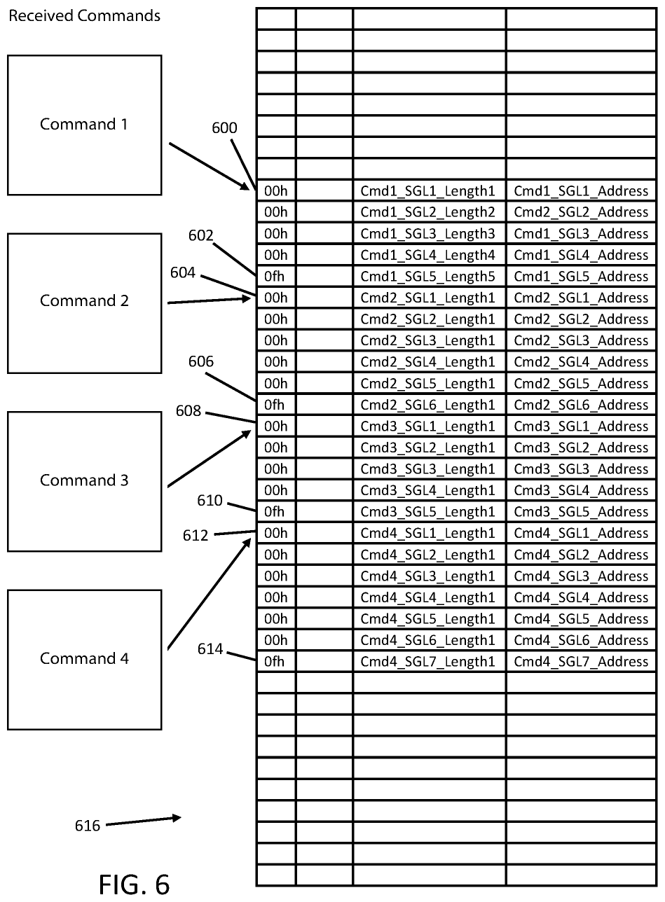

FIG. 6 illustrates an allocated memory space 616 in local memory, storing four contiguous pointer lists, each list associated with a particular command waiting for processing by controller CPU 200. Local memory address space is shown empty above SGL descriptor 600 and below SGL descriptor 614, representing memory locations where additional pointer lists may be stored. It should be understood that although FIG. 6 illustrates an allocation memory space in buffer memory 208 of only 41 memory addresses, comprising 4 pointer lists spanning 23 memory addresses, and 18 empty memory addresses, it should be understood that the allocated memory space in buffer memory 208 could be much larger, such as one million memory addresses, that many more than 4 pointer lists could be stored simultaneously within the address space, and that each pointer list could have fewer or a greater number SGL descriptor, PRP entries, or, in general, pointers.

Prefetch processor 204 first evaluates command 1, and constructs a first pointer list as shown, beginning at SGL descriptor 600 and ending at SGL descriptor 602, as denoted by the 0 fh descriptor.

Next, and before controller CPU has operated on command 1, prefetch processor 204 evaluates command 2, constructing a second pointer list in buffer memory 208, beginning at an address in buffer memory 208 that is contiguous with the address of SGL descriptor 602. The second pointer list begins at SGL descriptor 604 and ends at SGL descriptor 606.

Next, and before controller CPU has operated on command 1 or command 2, prefetch processor 204 evaluates command 3, constructing a third pointer list in buffer memory 208, beginning at an address in buffer memory 208 that is contiguous with the address of SGL descriptor 606. The third pointer list begins at SGL descriptor 608 and ends at SGL descriptor 610.

Finally, in this example, before controller CPU has operated on command 1, command 2 or command 3, prefetch processor 204 evaluates command 4, constructing a fourth pointer list in buffer memory 208, beginning at an address in buffer memory 208 that is contiguous with the address of SGL descriptor 610. The fourth pointer list begins at SGL descriptor 612 and ends at SGL descriptor 614.

At block 312, prefetch processor 204 may convert the information in the pointers from one format to another before storing the converted information in a pointer list. For example, prefetch processor 204 may convert the information found in either SGL descriptors or PRP entries to a common pointer format before storing these values in a pointer list. By converting pointer information from either format to a single, simple pointer format such as a format that comprises an starting address in local memory where the data is to be transferred and a length of the data to be transferred, controller 200 may process commands in either format, making design of controller CPU 200 much simpler than having controller CPU have to manage two formats. In some embodiments, this also allows for operating on commands in an “interleaved” fashion. For example, prefetch processor 204 may create a first pointer list by converting PRP entries associated with a first command from a first host processing system into a common format, and then by converting SGL descriptors associated with a second command from a second host processing system into the common format.

At block 314, in one embodiment, as the allocated memory space 616 for the pointer lists in buffer memory 208 is depleted (as pointer lists are created), prefetch processor 204 may alter the rate at which it processes the commands, in order to slow the rate of memory space deletion. Conversely, as controller CPU 200 processes commands using the pointer lists, increasing the memory space available in the allocated memory space 616, (as explained below), prefetch processor may increase its processing rate of the commands in order to ensure that at least one completed pointer list is available to controller CPU 200. For example, when prefetch processor 204 determines that the allocated memory space 616 in buffer memory 208 is 80% full based, in one embodiment, on the count value of the firmware counter, prefetch processor 204 may slow the rate of processing to 80% of the rate, or some other rate, at which it normally processes the commands. Of course, multiple thresholds could be allotted and when each threshold is reached, prefetch processor 204 could increase/reduce the rate at which commands are processed.

At block 316, after one or more pointer lists have been created by prefetch processor 204 and stored in local memory, controller CPU 200 may execute a first command. Controller CPU 200 may first determine whether the command requires more than the predetermined number of memory accesses in order to execute the command. If the command contains all of the pointer information to execute the command, then controller CPU 200 processes the command normally, i.e., uses the pointer information in the command to transfer data associate with the command to/from a memory address as specified by the pointer, such as a memory address of a buffer memory as part of the host processing system.

At block, 318, if the command requires more information than what is contained in the command in order to execute the command, controller CPU 200 determines whether one or more pointer lists is available in local memory. In one embodiment, controller processor 200 determines whether one or more pointer lists is available in local memory by evaluating the firmware counter (described above) to see if the firmware counter indicates the presence of one or more pointer lists, i.e., that it is equal to 1 or more.

At block 320, if controller CPU 200 determines that one or more pointer lists is available in local memory, controller CPU reads the first available pointer value in the first pointer list in local memory, and transfers data to/from a memory location in accordance with the pointer information (i.e., a location in a memory of the host processing system, or a memory within data transfer device 214. In one embodiment, after the data has been transferred, controller CPU 200 erases the pointer from the pointer list or, in another embodiment, causes prefetch processor 204 to erase the pointer.

At block 322, controller CPU 200 continues transferring data to/from memory locations in accordance with the next pointer and subsequent pointers in the pointer list, incrementing an address where each pointer is located in the pointer list sequentially.

At block 324, controller CPU 200 evaluates a pointer in the pointer list having a descriptor equal to a predetermined value, or code, that indicates that the pointer is the last pointer in the pointer list, i.e., the last pointer needed to complete execution of the command. In one embodiment, the value of the descriptor is “0 fh”, defined by the NVMe interface specification as being “vendor specific”. Controller CPU 200 uses the information in the last pointer to transfer the last portion of data needed to complete the command.

At block 326, controller CPU 200, in one embodiment, after completing the command, erases the pointer list from local memory or, in another embodiment, causes prefetch processor 204 to erase the pointer list.

At block 328, after completing the command, controller CPU 200 provides an indication that the pointer list has been fully utilized to execute the command, or that the pointer list has been erased. The indication may comprise controller CPU 200 sending the indication to prefetch processor 204 or altering the firmware counter. For example, controller CPU 200 may decrement the firmware counter by 1. In this way, controller CPU 200 knows how many pointer lists are stored in buffer memory 208 so it can continue processing commands until the counter indicates that no other pointer lists are available in local memory.

Although specific advantages have been enumerated above, various embodiments may include some, none, or all of the enumerated advantages.

Other technical advantages may become readily apparent to one of ordinary skill in the art after review of the following figures and description.

It should be understood at the outset that, although exemplary embodiments are illustrated in the figures and described below, the principles of the present disclosure may be implemented using any number of techniques, whether currently known or not. The present disclosure should in no way be limited to the exemplary implementations and techniques illustrated in the drawings and described below.

Unless otherwise specifically noted, articles depicted in the drawings are not necessarily drawn to scale.

Modifications, additions, or omissions may be made to the systems, apparatuses, and methods described herein without departing from the scope of the disclosure. For example, the components of the systems and apparatuses may be integrated or separated. Moreover, the operations of the systems and apparatuses disclosed herein may be performed by more, fewer, or other components and the methods described may include more, fewer, or other steps. Additionally, steps may be performed in any suitable order. As used in this document, “each” refers to each member of a set or each member of a subset of a set.

To aid the Patent Office and any readers of any patent issued on this application in interpreting the claims appended hereto, applicants wish to note that they do not intend any of the appended claims or claim elements to invoke 35 U.S.C. 112(f) unless the words “means for” or “step for” are explicitly used in the particular claim.

We claim:

1. A data transfer device for preprocessing a first command from a host processing system coupled to the data transfer device, comprising:
a memory for storing processor-executable instructions and a pointer list that identify pointers to memory addresses where data is to be transferred;
a controller CPU; and
a prefetch processor for executing the processor-executable instructions that causes the data transfer device to:
retrieve, by the prefetch processor, a first pointer from the first command;
retrieve, by the prefetch processor, a plurality of other pointers from a host processing system memory of the host processing system based on the first pointer;
store, by the prefetch processor in the memory, the plurality of other pointers in the pointer list; and
process, by the controller CPU, the first command using the plurality of pointers in the pointer list.

2. The data transfer device of claim 1, wherein the first pointer comprises a Physical Region Pointer (PRP).

3. The data transfer device of claim 1, wherein the first pointer comprises a Scatter Gather List (SGL).

4. The data transfer device of claim 1, wherein the processor-executable instructions that cause the data transfer device to retrieve the plurality of other pointers from the host processing system memory comprises instructions that cause the data transfer device to:
determine, by the prefetch processor, based on the first command, that a plurality of pointers is needed to process the first command by the controller CPU; and
in response to determining that a plurality of pointers is needed to process the first command by the controller CPU, retrieve, by the prefetch processor from the host processing system memory, the plurality of other pointers.

5. The data transfer device of claim 1, wherein the processor-executable instructions that cause the data transfer device to store the plurality of other pointers in the pointer list comprises instructions that cause the prefetch processor to:
replace, by the prefetch processor, a first descriptor of a first descriptor field of a last of the other pointers with a second descriptor to indicate to the controller CPU that there are no further pointers needed in the pointer list for the controller CPU to process the first command.

6. The data transfer device of claim 1, wherein the processor-executable instructions further comprise instructions that causes the data transfer device to:
provide, by the prefetch processor to the controller CPU, an indication that the pointer list is complete.

7. The data transfer device of claim 6, wherein the indication comprises incrementing a counter.

8. The data transfer device of claim 7, wherein the processor-executable instructions further comprise instructions that causes the data transfer device to:
decrement, by the controller CPU, the counter after the controller CPU has finished processing the first command.

9. The data transfer device of claim 1, wherein the processor-executable instructions that causes the controller CPU to process the first command comprises instructions that causes the controller CPU to:
retrieve the first command;
determine that the pointer list is complete; and
in response to determining that the pointer list is complete, process the first command using the completed pointer list in the local memory.

10. The data transfer device of claim 1, wherein the processor-executable instructions further comprise instructions that causes the data transfer device to:
retrieve, by the prefetch processor, a second pointer from a second command from the host processing system;
retrieve, by the prefetch processor, a second plurality of other pointers from the host processing system memory based on the second pointer;
store, by the prefetch processor in the memory, the second plurality of other pointers in a second pointer list sequentially to the first pointer list; and
process, by the CPU processor, the second command using the second plurality of other pointers stored in the second pointer list.

11. A method performed by a data transfer device for preprocessing a first command from a host processing system coupled to the data transfer device, comprising:
retrieving, by a prefetch processor, a first pointer from the first command;
retrieving, by the prefetch processor, a plurality of other pointers from a host processing system memory of the host processing system based on the first pointer;
storing, by the prefetch processor in a local memory, the plurality of other pointers in a pointer list; and
processing, by the controller CPU, the first command using the plurality of pointers in the pointer list.

12. The method of claim 11, wherein the first pointer comprises a Physical Region Pointer (PRP).

13. The method of claim 11, wherein the first pointer comprises a Scatter Gather List (SGL).

14. The method of claim 11, wherein retrieving the plurality of other pointers comprises:
determining, by the prefetch processor, based on the first command, that a plurality of pointers is needed to process the first command by the controller CPU; and
in response to determining that a plurality of pointers is needed to process the first command by the controller CPU, retrieving, by the prefetch processor from the host processing system memory, the plurality of other pointers.

15. The method of claim 11, wherein storing the plurality of other pointers in the pointer list comprises:
replacing, by the prefetch processor, a first descriptor of a first descriptor field of a last of the other pointers with a second descriptor to indicate to the controller CPU that there are no further pointers needed in the pointer list for the controller CPU to process the first command.

16. The method of claim 11, further comprising:
providing, by the prefetch processor to the controller CPU, an indication that the pointer list is complete.

17. The method of claim 16, wherein the indication comprises altering a counter.

18. The method of claim 17, further comprising:
altering, by the controller CPU, the counter after the controller CPU has finished processing the first command.

19. The method of claim 11, wherein processing the first command by the controller CPU comprises:
retrieving the first command;
determining that the pointer list is complete; and
in response to determining that the pointer list is complete, processing the first command using the completed pointer list in the local memory.

20. The method of claim 11, further comprising:
retrieving, by the prefetch processor, a second pointer from a second command from the host processing system;
retrieving, by the prefetch processor, a second plurality of other pointers from the host processing system memory based on the second pointer;
storing, by the prefetch processor in the memory, the second plurality of other pointers in a second pointer list sequentially to the first pointer list; and
processing, by the CPU processor, the second command using the second plurality of other pointers stored in the second pointer list.
